(19) United States
(12) Patent Application Publication
(10) Pub. No.: US 2015/0069944 A1
(43) Pub. Date: Mar. 12, 2015

(54) MOTOR DRIVING CONTROL APPARATUS, MOTOR DRIVING CONTROL METHOD AND MOTOR SYSTEM USING THE SAME

(71) Applicant: SAMSUNG ELECTRO-MECHANICS CO., LTD., Suwon (KR)

(72) Inventor: Joo Yul KO, Suwon (KR)

(73) Assignee: SAMSUNG ELECTRO-MECHANICS CO., LTD., Suwon (KR)

(21) Appl. No.: 14/086,957

(22) Filed: Nov. 21, 2013

(30) Foreign Application Priority Data
Sep. 6, 2013 (KR) 10-2013-0107345

(51) Int. Cl. H02P 6/18

(52) U.S. Cl. CPC H02P 6/182
USPC 318/400.35

(57) ABSTRACT

There are provided a motor driving control apparatus, a motor driving control method, and a motor system. The motor driving control apparatus includes: a zero-crossing detecting unit detecting back electromotive force generated in a motor apparatus and detecting a zero-crossing point of the back electromotive force; a commutation point calculating unit calculating an average value for zero-crossing points detected at least three times to determine a commutation point using the calculated average value; and a control unit controlling a phase change of the motor apparatus using the commutation point.

### CROSS-REFERENCE TO RELATED APPLICATION

This application claims the benefit of Korean Patent Application No. 10-2013-0107345 filed on Sep. 6, 2013, with the Korean Intellectual Property Office, the disclosure of which is incorporated herein by reference.

### BACKGROUND

The present disclosure relates to a motor driving control apparatus, a motor driving control method, and a motor system using the same.

As the motor technology evolves, motors having various sizes have been used in a wide range of technical fields.

Typically, a motor is driven by rotating a rotor using a permanent magnet and a coil having polarities changed according to a current applied thereto. An early example of such a motor is a brush-type motor having a coil on a rotor, which may have problems, for example, the brush included therein wearing out or sparks being generated due to the driving of the motor.

For this reason, various types of brushless motor are in common current use. Brushless motors are direct current motors from which mechanical contact parts such as a brush and a commutator are eliminated, and instead use electronic commutation elements. Typically, a brushless motor may include coils respectively corresponding to respective phases, a stator that generates magnetic force by a phase voltage in each of the coils, and a rotor that is formed of a permanent magnet and rotates due to magnetic force from the stator.

In order to control the driving of such a brushless motor, it is necessary to locate the position of the rotor so as to alternately provide a phase voltage. In order to locate the position of the rotor, back electromotive force has been used to estimate the position thereof. Based on the position of the rotor estimated thusly, the phase change time has been determined.

In this manner, however, if an error occurs in a zero-crossing point, the error is reflected in the phase change time, too. Therefore, the phase change may be performed inaccurately. That is, if an error occurs in generating or detecting back electromotive force, the zero-crossing point is shifted to be inaccurate, and thus an error occurs in the phase change time. Accordingly, reliability is reduced in motor driving.

The following Patent Documents relate to motor technology, but do not teach any technical feature allowing the above-mentioned problems to be overcome.

### RELATED ART DOCUMENTS

(Patent Document 1) Japanese Patent Laid-Open Publication No. 2012-060705

(Patent Document 2) Japanese Patent Laid-Open Publication No. 2012-080649

### SUMMARY

An aspect of the present disclosure may provide a motor driving control apparatus and a motor driving control method capable of accurately driving a motor by way of calculating an average value of zero-crossing points of back electromotive force to determine a commutation point using the average value, and a motor system using the same.

According to an aspect of the present disclosure, a motor driving control apparatus may include: a zero-crossing detecting unit detecting back electromotive force generated in a motor apparatus and detecting a zero-crossing point of the back electromotive force; a commutation point calculating unit calculating an average value for at least three detected zero-crossing points to determine a commutation point using the calculated average value; and a control unit controlling a phase change of the motor apparatus using the commutation point.

The zero-crossing detecting unit may include: a back-electromotive-force detector connected to each of phases of the motor apparatus to detect back electromotive force generated in one of the phases; and a zero-crossing point detector detecting a zero-crossing point at which the back electromotive force is inverted with reference to a predetermined value.

The commutation point calculating unit may calculate an average of the most recently detected zero-crossing point and the three previously-detected zero-crossing points and reflect the most recently detected zero-crossing point in the calculated average value to determine the commutation point.

The commutation point calculating unit may use an average of a zero-crossing point a single rotation previously and a current zero-crossing point of the motor apparatus, to determine the commutation point.

The commutation point calculating unit may calculate the commutation point using the following equation:

$$Tcp [ p ] = Tzcp [ p ] + \frac{Tzcp [ p ] - Tzcp [ p - n ]}{2 n}$$

where Tcp[p] denotes a current commutation point, Tzcp[p] denotes a current zero-crossing point, and Tzcp[p-n] denotes a zero-crossing point n times previously.

The commutation point calculating unit may include: a storage device storing the detected zero-crossing points sequentially; an average calculator calculating an average of a first zero-crossing point stored in the storage most recently and a zero-crossing point n times previously; and a commutation point calculator adding the first zero-crossing point to the calculated average value to determine a commutation point, wherein n is a natural number equal to or greater than 3.

The control unit may use the commutation point as a virtual hall sensor signal and change a driving current provided to at least a portion of the phases of the motor apparatus according to the virtual hall sensor signal.

According to another aspect of the present disclosure, a motor system may include: a motor apparatus rotating according to a driving signal; and a motor-driving control apparatus applying a predetermined averaging operation to back electromotive force detected in the motor apparatus and correcting a phase change time of the motor apparatus using the averaged back electromotive force.

The motor driving control apparatus may include: a zero-crossing detecting unit detecting back electromotive force generated in a motor apparatus and detecting a zero-crossing point of the back electromotive force; a commutation point calculating unit calculating an average value for at least three detected zero-crossing points to determine a commutation point CP using the calculated average value; and a control unit controlling a phase change of the motor apparatus using the commutation point.

The zero-crossing detecting unit may include: a back-electromotive-force detector connected to each of phases of the motor apparatus to detect back electromotive force generated in one of the phases; and a zero-crossing point detector detecting a zero-crossing point at which the back electromotive force is inverted with reference to a predetermined value.

The commutation point calculating unit may calculate an average of the most recently detected zero-crossing point and the three previously-detected zero-crossing points and reflect the most recently detected zero-crossing point in the calculated average value to determine the commutation point.

The commutation point calculating unit may use an average of the zero-crossing point a single rotation previously and the current zero-crossing point of the motor apparatus, to determine the commutation point.

The commutation point calculating unit may calculate the commutation point using the following equation:

$$Tcp [ p ] = Tzcp [ p ] + \frac{Tzcp [ p ] - Tzcp [ p - n ]}{2 n}$$

where Tcp[p] denotes a current commutation point, Tzcp[p] denotes a current zero-crossing point, and Tzcp[p-n] denotes a zero-crossing point n times previously.

The commutation point calculating unit may include: a storage device storing the detected zero-crossing points sequentially; an average calculator calculating an average of a first zero-crossing point stored in the storage most recently and a zero-crossing point n times previously; and a commutation point calculator adding the first zero-crossing point to the calculated average value to determine a commutation point, wherein n is a natural number equal to or greater than 3.

The control unit may use the commutation point as a virtual hall sensor signal and change a driving current provided to at least a portion of the phases of the motor apparatus according to the virtual hall sensor signal.

According to another aspect of the present disclosure, a motor driving control method performed in a motor driving control apparatus for controlling a motor apparatus may include: detecting back electromotive force generated in a motor apparatus and detecting a zero-crossing point of the back electromotive force; determining a commutation point by applying an average value of at least three detected zero-crossing points; and controlling the motor apparatus so that a phase of the motor apparatus is changed at the commutation point.

The determining of the commutation point may include calculating an average value of a most recently detected zero-crossing point and three previously-detected zero-crossing points and reflecting the most recently detected zero-crossing point in the calculated average value to determine the commutation point.

The determining of the commutation point may include calculating the commutation point using the following equation:

$$Tcp [ p ] = Tzcp [ p ] + \frac{Tzcp [ p ] - Tzcp [ p - n ]}{2 n}$$

where Tcp[p] denotes a current commutation point, Tzcp[p] denotes a current zero-crossing point, and Tzcp[p-n] denotes a zero-crossing point n times previously.

The determining of the commutation point may include: storing the detected zero-crossing points sequentially; calculating an average value of a first zero-crossing point stored in the storage device most recently and a zero-crossing point n times previously; and adding the first zero-crossing point to the calculated average value to determine the commutation point.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram illustrating a motor system according to an exemplary embodiment of the present disclosure;

FIG. 2 is a diagram illustrating zero-crossing points and commutation points;

FIG. 3 is a block diagram illustrating an example of the zero-crossing detecting unit 100 of FIG. 1;

FIG. 4 is a block diagram illustrating an example of the zero-crossing calculating unit of FIG. 1;

FIGS. 5 through 7 are diagrams for illustrating a process of correcting a commutation point according to an exemplary embodiment of the present disclosure; and

FIG. 8 is a flowchart illustrating a motor driving control method according to an exemplary embodiment of the present disclosure.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

In the following description, a motor apparatus 200 refers to a motor, and a motor system refers to a system that includes the motor apparatus 200 and a motor driving control apparatus 100 for driving the motor apparatus 200.

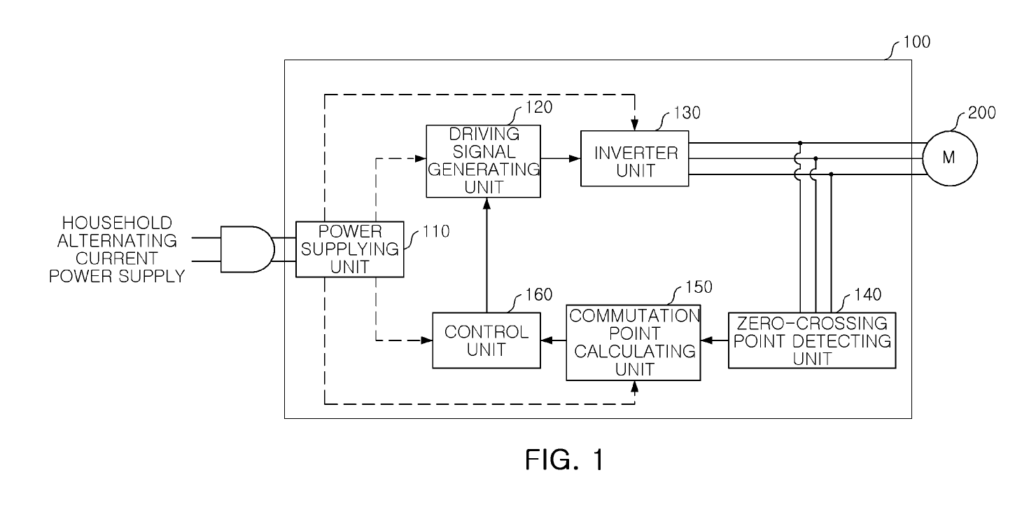

FIG. 1 is a block diagram for illustrating a motor system according to an exemplary embodiment of the present disclosure.

A motor driving control apparatus 100 may control the rotation of the motor apparatus 200 by providing a predetermined signal, e.g., a driving signal, to the motor apparatus 200.

In an exemplary embodiment, the motor driving control apparatus 100 may apply a predetermined averaging operation to back electromotive force detected in the motor apparatus 200 and may correct a phase change time of the motor apparatus 200 using the averaged back electromotive force.

The motor apparatus 200 may rotate according to the driving signal. For example, each of the coils in the motor apparatus 200 may generate a magnetic field according to the driving current (driving signal) provided from the inverter unit 130. The rotor included in the motor apparatus 200 may be rotated by the magnetic fields generated in the coils as described above.

Specifically, the motor driving control apparatus 100 may include a power supply unit 110, a driving signal generating unit 120, an inverter unit 130, a zero-crossing detecting unit 140, a commutation point calculating unit 150, and a control unit 160.

The power supply unit 110 may supply power to each of the components in the motor driving control apparatus 100. For example, the power supply unit 110 may convert a household alternating current (AC) voltage into a direct current (DC) voltage to supply the converted DC voltage. In the example shown, a dashed line represents a predetermined power supplied from the power supply unit 110.

The driving signal generating unit 120 may control the inverter unit 130 so that it generates a driving signal.

The inverter unit 130 may provide a driving signal to the motor apparatus 200. For example, the inverter unit 130 may convert a direct current voltage into a polyphase (e.g., three-phase) voltage according to a predetermined signal provided from the driving signals generating unit 120. The inverter unit 130 may apply multiple phase voltages to the coils in the motor apparatus 200, each of which corresponds to a respective phase, so that rotor of the motor apparatus 200 may be operated.

The zero-crossing detecting unit 140 may detect back electromotive force generated from the motor apparatus 200 and may detect a zero-crossing point in the back electromotive force.

The commutation point calculating unit 150 may calculate an average value of the at least three detected zero-crossing points which have been, to determine a commutation point CP using the calculated average value.

In an exemplary embodiment, the commutation point calculating unit 150 may calculate an average of the most recently detected zero-crossing point and three previously-detected zero-crossing points and reflect the most recently detected zero-crossing point in the calculated average value to determine the commutation point.

In an exemplary embodiment, the commutation point calculating unit 150 may use an average of the zero-cross point a single rotation previously and the current zero-crossing point of the motor apparatus 200, to determine the commutation point. For example, in the case of a three-phase motor, an average of the current zero-crossing point and a zero-crossing point 6 times previously is calculated and reflected in the current zero-crossing point, to calculate the commutation point.

In an exemplary embodiment, the commutation point calculating unit 150 may calculate the commutation point according to Equation 1 below:

$$Tcp [ p ] = Tzcp [ p ] + \frac{Tzcp [ p ] - Tzcp [ p - n ]}{2 n} \qquad [ Equation 1 ]$$

where Tcp[p] denotes current commutation point, Tzcp[p] denotes current zero-crossing point, and Tzcp[p-n] denotes a zero-crossing point n times previously.

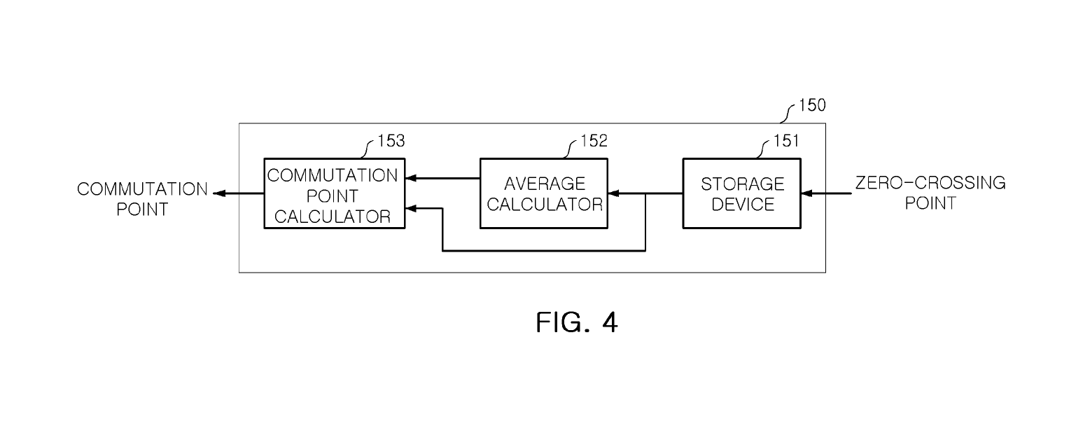

The commutation point calculating unit 150 will be described below in more detail with reference to FIGS. 4 to 7.

The control unit 160 may control the phase change of the motor apparatus 200 using the commutation point determined by the commutation point calculating unit 150. The control unit 160 may control the driving signal so that the phase change occurs at the commutation point.

In an exemplary embodiment, the control unit 160 may use the commutation point as a virtual hall sensor signal and may change the driving current provided to at least a portion of the phases of the motor apparatus 200 according to the virtual hall sensor signal.

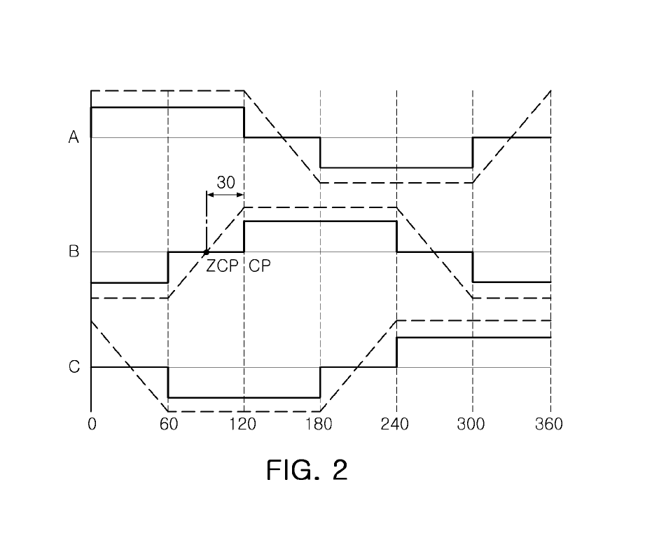

FIG. 2 is a diagram illustrating typical zero-crossing points and commutation points. FIG. 2 illustrates a three-phase motor apparatus having phase A, phase B and phase C.

Hereinafter, a typical method of determining commutation point will be described with reference to FIG. 2.

The solid lines in FIG. 2 refer to driving signals for respective phases that the motor-driving control apparatus provides to the motor apparatus. For example, a pulse-width modulation (PWM) signal may be used as the driving signal.

The dashed lines refer to back electromotive forces possibly generated in each of the phases by the driving of the motor apparatus. As shown, at the zero-crossing points ZCP, the sign of the back electromotive force may be inverted.

Since a three-phase motor is used in the example shown, the cycle of the phase change is 60 degrees. Therefore, the motor driving control apparatus may set the commutation point CP by adding 30 degrees to the detect zero-crossing point ZCP and may perform a phase change according to the set commutation point CP.

In the example of phase B, no driving signal is provided to phase B until a zero-crossing point ZCP is detected. When a zero-crossing point ZCP is detected from phase B, a commutation point CP is calculated by adding 30 degrees to the detected point, and the driving signal is applied to phase B at the commutation point CP.

As described above, generally, in the case that the cycle of the phase change is 60 degrees, a commutation point CP is determined with reference to the half of the 60 degrees.

In this case, however, if an error occurs in detecting a zero-crossing point ZCP, the error affects on the phase changes.

According to the exemplary embodiments of the present disclosure, in order to prevent such an error, an average value of the zero-crossing points ZCP may be used.

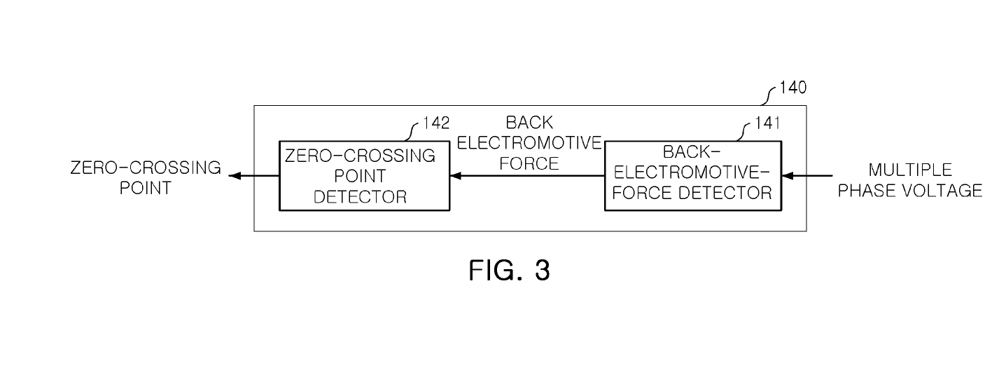

Various exemplary embodiments of the present disclosure will be described in more detail with reference to FIGS. 3 to 7.

FIG. 3 is a block diagram illustrating the zero-crossing detecting unit 140 in FIG. 1 according to an exemplary embodiment.

Referring to FIG. 3, the zero-crossing detecting unit 140 may include a back-electromotive-force detector 141 and a zero-crossing detector 142.

The back-electromotive-force detector 141 may be connected to the multiple phases of the motor apparatus 200 so as to detect back electromotive force generated in any of the phases.

More specifically, while the motor apparatus 200 is being rotated, back electromotive force is generated in the coils provided in the stator by the rotation of the rotor. That is, back electromotive force may be generated in one of the coils to which no phase voltage is applied, and the zero-crossing detecting unit 140 may receive the phase voltages from the coils of the motor apparatus 200 and detect back electromotive force from the coil to which no phase voltage is applied.

Here, a phase from which no back electromotive force is detected is a phase to which no driving signal is currently being applied. For example, in a three-phase motor having phase a, phase b, and phase c, in the case that a positive (+) signal is applied to phase a and a negative (−) signal is applied to phase c, back electromotive force may be detected from phase b. This is because electromotive (back electromotive) force is generated in phase b to which no signal is applied as the rotor rotates due to the magnetic field in phases a and c.

The zero crossing detector 142 may detect a zero-crossing point at which back electromotive force is inverted with reference to a predetermined value. For example, as shown in FIG. 2, the zero-crossing detector 142 may detect a zero-crossing point ZCP when the value of back electromotive force is inverted from a positive value to a negative value or vice versa. This is the case in the example in FIG. 2, in which zero-crossing points are detected with reference to the value of 0.

FIG. 4 is a block diagram illustrating an example of the commutation point calculating unit 150 in FIG. 1. In the following, the example of the commutation point calculating unit 150 will be described in more detail with reference to FIG. 4.

Referring to FIG. 4, the commutation point calculating unit 150 may include a storage device 151, an average calculator 152, and a commutation point calculator 153.

The storage device 151 may store zero-crossing points detected by the zero-crossing detecting unit 140 sequentially. For example, the storage device 151 may be a memory device having a storage space such as a register.

The average calculator 152 may calculate an average value of a first zero-crossing point stored in the storage device 151 most recently and a zero-crossing point n times previously. The value of n may be a natural number equal to or larger than 3.

The average value calculated by the average calculator 152 may be used for calculating a commutation point.

Specifically, in the example in FIG. 2, a commutation point is calculated by adding 30 degrees to a current zero-crossing point (i.e., a zero-crossing point stored in an adder most recently). In contrast, in an exemplary embodiment of the present disclosure, a commutation point may be calculated by adding an average value calculated by the average calculator 152 to a current zero-crossing point. This is to correct an error possibly occurring in the current zero-crossing point so as to avoid the error from being reflected in calculating the commutation point.

The commutation point calculator 153 may determine a commutation point by adding a current zero-crossing point to the calculated average value.

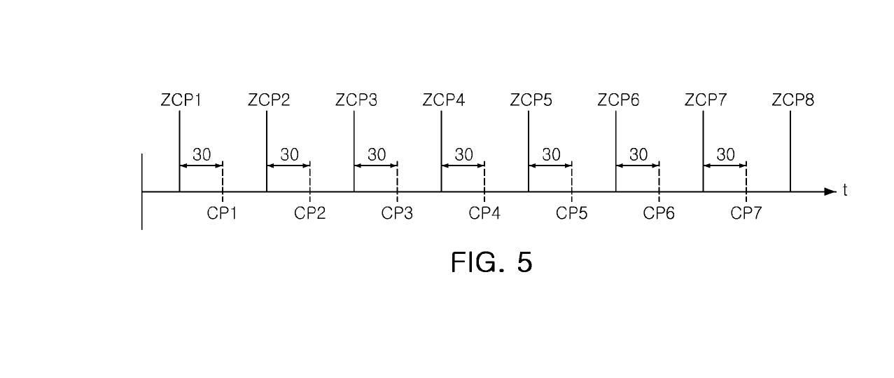

Hereinafter, a process of correcting a commutation point according to an exemplary embodiment of the present disclosure will be described with reference to FIGS. 5 to 7.

FIG. 5 illustrates an example of a process of determining a commutation point CP typically used in three-phase motors. That is, as described above with reference to FIG. 2, the cycle of detecting zero-crossing points ZCP1 to ZCP8 may be 60 degrees, and the commutation points CP1 to CP7 may be determined by adding 30 degrees to each of the zero-crossing points ZCP1 to ZCP7.

According to this process, if an error occurs in a zero-crossing point, the error is reflected in calculating a commutation point, and thus an error occurs in controlling the phase change as well.

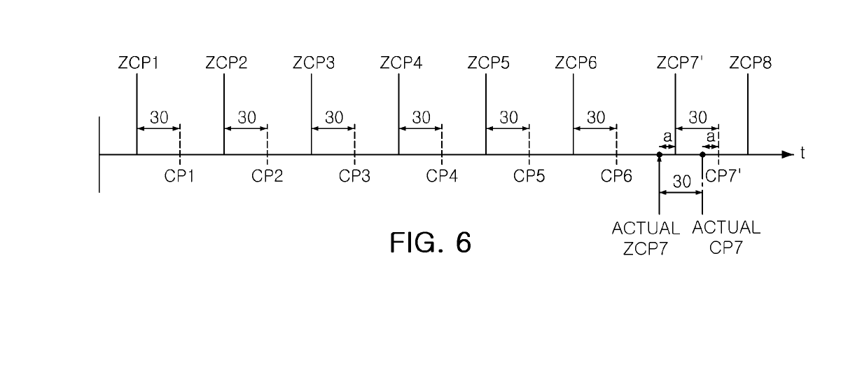

FIG. 6 illustrates commutation points CPs when an error has occurred in a three-phase motor. That is, according to this typical process illustrated in FIG. 5, an error illustrated in FIG. 6 may occur.

As can be seen from FIG. 6, the seventh zero-crossing point ZCP7′ has an error a with respect to the right zero-crossing point ZCP 7.

It can be seen that the phase should be changed at the commutation point CP7 based on the correct zero-crossing point ZCP7, but is actually changed at the commutation point CP7′, based on the erroneous zero-crossing point ZCP7′, with an error a.

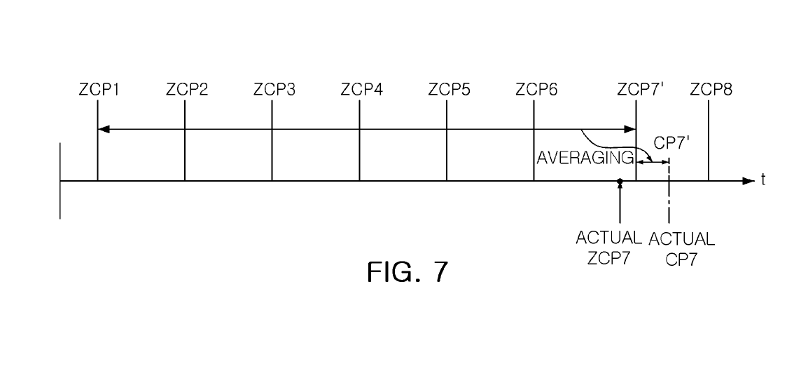

FIG. 7 illustrates an example of a process of determining a commutation point CP according to an exemplary embodiment of the present disclosure.

In the example in FIG. 7, the value of n is 6. In the case of three-phase motors, six zero-crossing points are detected per rotation. The example in FIG. 7 illustrates averaging for one rotation of a three-phase motor.

In FIG. 7, in calculating seventh commutation point CP7, according to the exemplary embodiment of the present disclosure, an average value of the previously detected six zero-crossing points is calculated and is added, to correct an error.

That is, as described in relation to Equation 1, an average value of from ZCP1 to ZCP7 is calculated and the average value thus calculated is added to a current ZCP7′, to determine a commutation point CP7′ more accurately.

Although there is only one error occurring in FIG. 7, it is apparent that as more errors occur in detecting zero-crossing points, commutation points may be calculated more accurately according to the exemplary embodiment of the present disclosure. That is, since positive (+) errors and negative (−) errors may randomly occur in detecting zero-crossing points, according to the exemplary embodiment of the present disclosure, averaging may be performed for those error as well so that commutation points may be calculated more accurately.

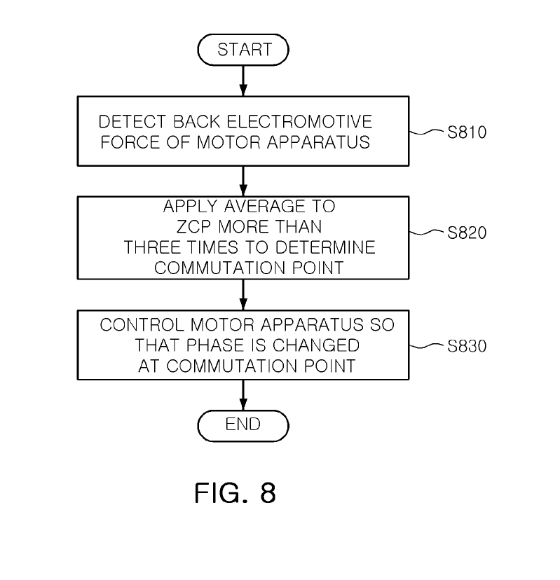

FIG. 8 is a flow chart for illustrating a method for motor driving control according to an exemplary embodiment of the present disclosure.

Hereinafter, a method for a motor driving control according to the exemplary embodiment of the present disclosure will be described with reference to FIG. 8. Since the method for motor driving control according to the exemplary embodiment is performed in the motor driving control apparatus 100 described above with reference to FIGS. 1 to 7, overlapped descriptions of elements the same as or corresponding to the above-mentioned parts will be omitted.

Referring to FIGS. 1 to 8, the motor driving control apparatus 100 may detect back electromotive force generated from the motor apparatus 200 and may detect zero-crossing points of the back electromotive force (S810).

Then, the motor driving control apparatus 100 may apply an average to the zero-crossing points detected at least three times, to determine commutation points (S820).

Once the commutation points are determined, the motor driving control apparatus 100 may control the motor apparatus 200 so that phases of the motor apparatus 200 are changed at the commutation points (S830).

In operation S820, the motor driving control apparatus 100 may calculate an average of the most recently detected zero-crossing point and three previously-detected zero-crossing points. Then, the motor driving control apparatus 100 may reflect the most recently detected zero-crossing point to the calculated average value to determine a commutation point.

In operation S820, the commutation points may be calculated using Equation 1.

In operation S820, the motor driving control apparatus 100 may store the detected zero-crossing points sequentially. The motor driving control apparatus 100 may calculate an average value of a first zero-crossing point stored in the storage device 151 most recently, and a zero-crossing point n times previously. Then, the motor driving control apparatus 100 may add the first zero-crossing point to the calculated average value to determine a commutation point.

As set forth above, according to exemplary embodiments of the present disclosure, a motor apparatus can be accurately driven byway of calculating an average value of zero-crossing points of back electromotive force to determine a commutation point using the average value.

While exemplary embodiments have been shown and described above, it will be apparent to those skilled in the art that modifications and variations could be made without departing from the spirit and scope of the present disclosure as defined by the appended claims.

What is claimed is:

1. A motor driving control apparatus, comprising:
a zero-crossing detecting unit detecting back electromotive force generated in a motor apparatus and detecting a zero-crossing point of the back electromotive force;
a commutation point calculating unit calculating an average value for zero-crossing points detected at least three times to determine a commutation point using the calculated average value; and
a control unit controlling a phase change of the motor apparatus using the commutation point.

2. The motor driving control apparatus of claim 1, wherein the zero-crossing detecting unit includes:
a back-electromotive-force detector connected to each of phases of the motor apparatus to detect back electromotive force generated in one of the phases; and
a zero-crossing point detector detecting a zero-crossing point at which the back electromotive force is inverted with reference to a predetermined value.

3. The motor driving control apparatus of claim 1, wherein the commutation point calculating unit calculates an average value of a most recently detected zero-crossing point and three previously-detected zero-crossing points and reflects the most recently detected zero-crossing point in the calculated average value to determine the commutation point.

4. The motor driving control apparatus of claim 1, wherein the commutation point calculating unit uses an average of a zero-crossing point one rotation previously by the motor apparatus and a current zero-crossing point to determine the commutation point.

5. The motor driving control apparatus of claim 1, wherein the commutation point calculating unit calculates the commutation point using the following equation:
$$Tcp [ p ] = Tzcp [ p ] + \frac{Tzcp [ p ] - Tzcp [ p - n ]}{2 n}$$
where Tcp[p] denotes a current commutation point, Tzcp[p] denotes a current zero-crossing point, and Tzcp[p-n] denotes a zero-crossing point n times previously.

6. The motor driving control apparatus of claim 1, wherein the commutation point calculating unit includes:
a storage device storing the detected zero-crossing points sequentially;
an average calculator calculating an average value of a first zero-crossing point stored in the storage device most recently and a zero-crossing point n times previously; and
a commutation point calculator adding the first zero-crossing point to the calculated average value to determine a commutation point, wherein n is a natural number equal to or greater than 3.

7. The motor driving control apparatus of claim 1, wherein the control unit uses the commutation point as a virtual hall sensor signal and changes a driving current provided to at least a portion of the phases of the motor apparatus according to the virtual hall sensor signal.

8. A motor system, comprising:
a motor apparatus rotating according to a driving signal; and
a motor driving control apparatus applying a predetermined averaging operation to back electromotive force detected in the motor apparatus and correcting a phase change time of the motor apparatus using the averaged back electromotive force.

9. The motor system of claim 8, wherein the motor driving control apparatus includes:
a zero-crossing detecting unit detecting back electromotive force generated in a motor apparatus and detecting a zero-crossing point of the back electromotive force;
a commutation point calculating unit calculating an average value for zero-crossing points detected at least three times to determine a commutation point using the calculated average value; and
a control unit controlling a phase change of the motor apparatus using the commutation point.

10. The motor system of claim 9, wherein the zero-crossing detecting unit includes:
a back-electromotive-force detector connected to each of phases of the motor apparatus to detect back electromotive force generated in one of the phases; and
a zero-crossing point detector detecting a zero-crossing point at which the back electromotive force is inverted with reference to a predetermined value.

11. The motor system of claim 9, wherein the commutation point calculating unit calculates an average value of a most recently detected zero-crossing point and three previously-detected zero-crossing points and reflects the most recently detected zero-crossing point in the calculated average value to determine the commutation point.

12. The motor system of claim 11, wherein the commutation point calculating unit uses an average of a zero-crossing point one rotation previously by the motor apparatus and a current zero-crossing point to determine the commutation point.

13. The motor system of claim 9, wherein the commutation point calculating unit calculates the commutation point using the following equation:
$$Tcp [ p ] = Tzcp [ p ] + \frac{Tzcp [ p ] - Tzcp [ p - n ]}{2 n}$$
where Tcp[p] denotes a current commutation point, Tzcp[p] denotes a current zero-crossing point, and Tzcp[p-n] denotes a zero-crossing point n times previously.

14. The motor system of claim 9, wherein the commutation point calculating unit includes:
a storage device storing the detected zero-crossing points sequentially;
an average calculator calculating an average value of a first zero-crossing point stored in the storage device most recently and a zero-crossing point n times previously; and
a commutation point calculator adding the first zero-crossing point to the calculated average value to determine a commutation point,
wherein n is a natural number equal to or greater than 3.

15. The motor system of claim 9, wherein the control unit uses the commutation point as a virtual hall sensor signal and changes a driving current provided to at least a portion of the phases of the motor apparatus according to the virtual hall sensor signal.

16. A motor driving control method performed in a motor driving control apparatus for controlling a motor apparatus, the motor driving control method comprising:
detecting back electromotive force generated in a motor apparatus and detecting a zero-crossing point of the back electromotive force;
determining a commutation point by applying an average value of at least three detected zero-crossing points; and
controlling the motor apparatus so that a phase of the motor apparatus is changed at the commutation point.

17. The motor driving control method of claim 16, wherein the determining of the commutation point includes calculating an average value of a most recently detected zero-crossing point and three previously-detected zero-crossing points and reflecting the most recently detected zero-crossing point in the calculated average value to determine the commutation point.

18. The motor driving control method of claim 16, wherein the determining of the commutation point includes calculating the commutation point using
$$Tcp [ p ] = Tzcp [ p ] + \frac{Tzcp [ p ] - Tzcp [ p - n ]}{2 n}$$
where Tcp[p] denotes a current commutation point, Tzcp[p] denotes a current zero-crossing point, and Tzcp[p-n] denotes a zero-crossing point n times previously.

19. The motor driving control method of claim 16, wherein the determining of the commutation point includes:
storing the detected zero-crossing points sequentially;
calculating an average value of a first zero-crossing point stored in the storage device most recently and a zero-crossing point n times previously; and
adding the first zero-crossing point to the calculated average value to determine the commutation point.
